(19) United States
(12) Patent Application Publication
(10) Pub. No.: US 2017/0357235 A1
(43) Pub. Date: Dec. 14, 2017

(54) Method for Checking at least one Telegram

(71) Applicant: Endress + Hauser Process Solutions AG, Reinach (CH)

(72) Inventors: Michael Mayer, Oberwil (CH); Ingomar Sotriffer, Efringen-Kirchen (DE); David Sutter, Michelbach-Le-Haud (FR)

(21) Appl. No.: 15/535,517

(22) PCT Filed: Nov. 18, 2015
(86) PCT No.: PCT/EP2015/076904

§ 371 Date: Jun. 13, 2017

(30) Foreign Application Priority Data
Dec. 19, 2014 (DE) 10 2014 119 214.1

(51) Int. Cl. G05B 19/042; H04L 29/08; G06F 21/56

(52) U.S. Cl. CPC G05B 19/0428; H04L 67/12; G06F 21/56

(57) ABSTRACT

Method for checking at least one telegram (T1) transmitted via a fieldbus according to a fieldbus protocol, wherein the telegram (T1), which has at least one data block (D1, D2), is received by a field device (FD), which field device (FD) has a first function block (RE) for preprocessing the received telegram (T1), wherein based on the preprocessing it is checked whether the data contained in the at least one data block (D1, D2) correspond to predetermined criteria furnished in the field device, for example, a predetermined value or a predetermined value range (Cmd#, Length, byte start, etc), wherein based on the checking it is determined, whether the received data are forwarded to a second function block (MP, IO) for further processing of the received data in the field device (FD).

The invention relates to a method for checking at least one telegram, as well as to a field device.

In plants of process automation technology, field devices are applied for control or monitoring of processes running therein. The terminology, field devices, means, in such case, in principle, all devices, which are applied near to the process and deliver, or process, process relevant information. Besides measuring devices/sensors, and actuators and display/interaction units, generally also referred to as a field devices are items, which, for example, are directly connected to a fieldbus and serve for communication with superordinated units, i.e. items such as remote I/Os, gateways, linking devices and radio units.

Known from patent application DE 102010063773 A1 is to provide in a field device two differently configured memory ranges, in which data can be stored. In such case, safety-relevant data are written into a first memory range. Data, which require no special testing, are written into the second memory range.

Known, furthermore, from patent application DE 10148029 A1 is a method for data backup in the case of a field device. In such case, data from a second memory are written into a first memory in case of malfunction.

In such case, however, the data are not checked as regards content, but, instead, only for consistency, for example, by means of a checksum. Data false as regards content, for example surreptitiously changed data, cannot be detected. Especially, according to the known methods, data are thus first stored, before they are checked. This means that damage can happen, because a field device operates in an unpermitted configuration. This can lead, for example, to damage in the plant containing the field device. Moreover, due to malicious software or the malicious changing of field device referenced data, even another device in communication with the field device can be damaged.

Starting from the above described state-of-the-art, it is an object of the invention to improve information security in an industrial plant, especially in the case of the transferring of data to a field device or from a field device.

The object is achieved by a method and a field device.

As regards the method, the object is achieved by a method for checking at least one telegram transmitted via a fieldbus according to a fieldbus protocol, wherein the telegram, which has at least one data block, is received by a field device, which field device has a first function block for preprocessing the received telegram, wherein based on the preprocessing it is checked whether the data contained in the at least one data block correspond to predetermined criteria, for example, a predetermined value or a predetermined value range furnished in the field device, wherein based on the checking it is determined, whether the received data are forwarded to a second function block for further processing of the received data in the field device.

The telegram can, in such case, be constructed, for example, corresponding to a fieldbus protocol, such as, for example, HART, PROFIBUS, Foundation Fieldbus, or a like protocol. The telegram can, thus, for example, have a header and a data block connected thereto. The data block can, in turn, have a user data block and, in given cases, further data blocks, such as, for example, first and second data blocks and/or a data block, which contains a checksum. The data block can contain, for example, a command according to a fieldbus protocol. By means of the command, for example, functions of a field device associated with the command can be invoked and/or data can be downloaded from or by a field device. Furthermore, the telegram can contain supplementally field device referenced data such as, for example, parameter values, which have to be transmitted to a field device or come from a field device. Furthermore, the data contained in the telegram and/or data block can be intended for storage in the field device. In general, thus, of concern is field device referenced data, which are either processed in the field device or are used for characterizing and/or identification of the field device.

The field device can have one or more function blocks, which serve for processing data, for example, the received data or other field device referenced data. For example, a function block can be provided, which serves for processing measured values. This function block can serve, for example, to convert a measurement signal into a measured value. In such case, of concern, for example, can be the firmware or a part of the firmware of the field device. This firmware can quite generally serve for providing and for performing the functions and functionalities of the field device. The first and/or the second function block can be a component of this firmware. The first and second function blocks can serve, for example, likewise for preprocessing a telegram received, for example, via a fieldbus, to which the field device is connected. The first function block can, furthermore, be integrated in another function block or be in communication connection with such, so that a data exchange is possible. The first function block can serve, for example, to process a received telegram and forward the result to a communication stack, also a component referred to as a protocol stack, which serves to identify the different data blocks and forward them to the component, or the function block, which serves for (additionally) processing the data contained therein. On the other hand, the first function block can also be (logically) arranged between the communication stack and a second function block. In this way, it is possible to check the content of the received data block for predetermined criteria, before a processing, forwarding and/or storing of the data occurs.

For example, based on the first function block and the used criteria, it can be checked whether the data have or include a certain value or lie in a certain value range. These criteria can be furnished or stored, for example, in a memory unit, for example, in the form of a table. In such case, for example, a comparison of the received data of one or more data blocks with one or more of the furnished criteria can occur. Additionally, also the data, or data blocks, of a number of telegrams can be collected and checked, for example, before being forwarded to the second function block or stored in a memory unit or a memory range, to which the second function block has access.

The checking can relate, for example, to the content of the received data, i.e. a semantic analysis can be performed—thus whether, as regards content, valid data are present.

Besides the checking of the data in the data block as regards content, also a checking of the received data as regards consistency, for example, for errors in the data transmission, can occur. This can occur, for example, by means of a checksum, which was likewise received by the field device in connection with the at least one telegram.

Additionally, the first function block can also be used for checking telegrams, or data, which are to be transmitted via a fieldbus by means of at least one telegram. The first function block checks, thus, data received by and/or sent by the field device.

As a function of checking, the first function block can forward the data contained in the data blocks to the second function block or write such into a memory unit, or memory range. To this end, a number of memory ranges can be provided, which are physically and/or logically separated from one another. Thus, for example, a first memory range can serve to store data, which does not pass the checking, separated from data, which has passed a checking by the first function block. Preferably, in such case, a physically separated memory range, for example, in a separate memory unit, is provided.

The first function block can serve, for example, for copying the data from a first memory range into a second memory range.

By checking based on the first function block, the storing and/or processing of surreptitiously changed data is prevented. In this way, on the one hand, information security, and, on the other hand, as a result of this, also plant safety, are assured. By the checking and by the criteria used for the checking, unauthorized execution of code or other attack scenarios, such as, for example, a buffer overflow, can be prevented, in that at least one part of the data in the data block of the received at least one telegram are checked, for example, by criteria set by the manufacturer of the field device. The criteria can be protocol specific criteria, such as, for example, the presence of control characters in a data block and/or the length of a data block, i.e. the amount of data contained therein. For example, by means of the first function block, it can be checked whether the data is data foreign to the protocol, thus data, which does not lie in a value range or which does not correspond to a command, which is specified by or conforms to the protocol, by means of which the field device communicates. For example, it can be checked whether the data involves commands of an impermissible format, for whose processing the field device is not adapted, or which are from another protocol.

In a form of embodiment of the method, the received data are written, as a function of the checking, into a first memory range or into a second memory range in the field device. As already mentioned, the memory units can, in such case, be physically and locationally separated.

In an additional form of embodiment of the method, the first memory range serves to store, persistently, data, which do not fulfill the predetermined criteria. These data can be used later for analysis of an attempt to write unpermitted data into a field device or to store it there.

In an additional form of embodiment of the method, the second memory range serves to provide the received data to the second function block in the field device, by which second function block the received data are further processed.

In an additional form of embodiment of the method, the first function block checks, whether a first portion of data contained in the data block corresponds to a first criterion.

In an additional form of embodiment of the method, the first function block checks, whether a second portion of data contained in the data block, different from the first portion, corresponds to a second criterion.

In an additional form of embodiment of the method, the telegram, thus, includes first and second data blocks, and wherein in the field device a first set of criteria is furnished, based on which the first data block is checked, wherein in the field device a second set of criteria is furnished, based on which the second data block is checked, wherein the first and second sets of criteria differ from one another.

In an additional form of embodiment of the method, the telegram, i.e. the at least one data block, is written into a third memory range of the field device before the checking by the first function block.

In an additional form of embodiment of the method, as a function of the checking, the data are written, preferably copied, from the third memory range either into the first or into the second memory range.

In an additional form of embodiment of the method, the criteria, based on which the telegram, i.e. the data, is/are checked, are stored in a fourth memory range in the field device.

In an additional form of embodiment of the method, using the criteria, it is checked whether the values contained in the data block lie within a predetermined value range, for example, in a predetermined hexadecimal value range. The data block can be divided for this into different portions, or ranges.

In an additional form of embodiment of the method, it is checked, based on the criteria, whether the data block exceeds a predetermined amount of data.

As regards the field device, the object is achieved by a field device having a first function block, which serves for preprocessing a received telegram, which has at least one data block, wherein the first function block serves, furthermore, to check whether the data contained in the at least one data block meet predetermined criteria furnished in the field device, for example, have a predetermined value or a predetermined value range, and whether it is permissible to forward the received data to a second function block for further processing of the received data in the field device.

In a form of embodiment of the field device, the field-device includes a first memory range and a second memory range, in which the received data are stored as a function of checking by the first function block.

The invention will now be explained in greater detail based on the appended drawing, the figures of which show as follows:

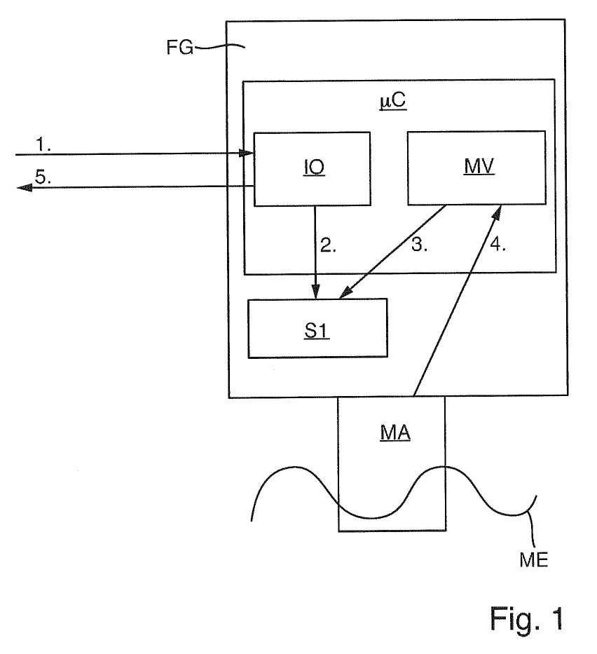

FIG. 1 a schematic representation of a field device,

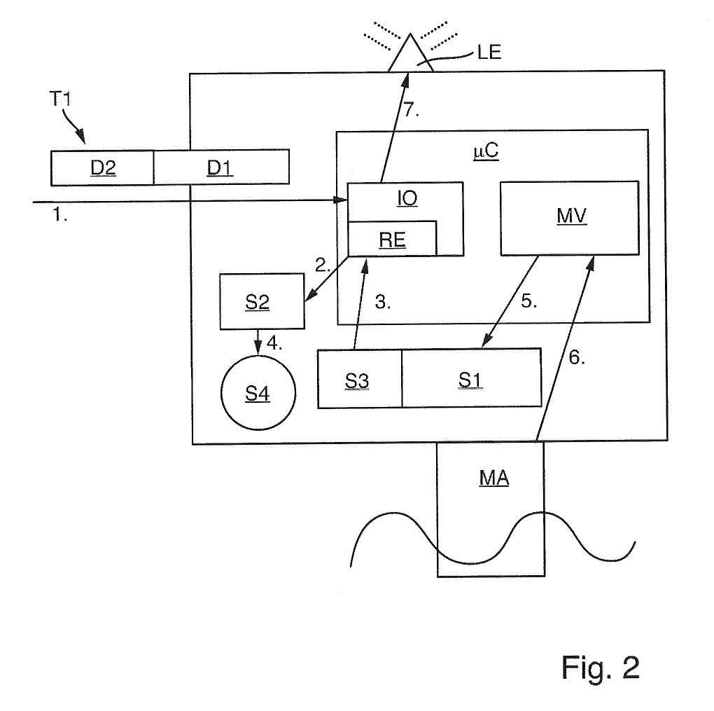

FIG. 2 a schematic representation of a field device having a first function block for checking a received data block based on predetermined is criteria,

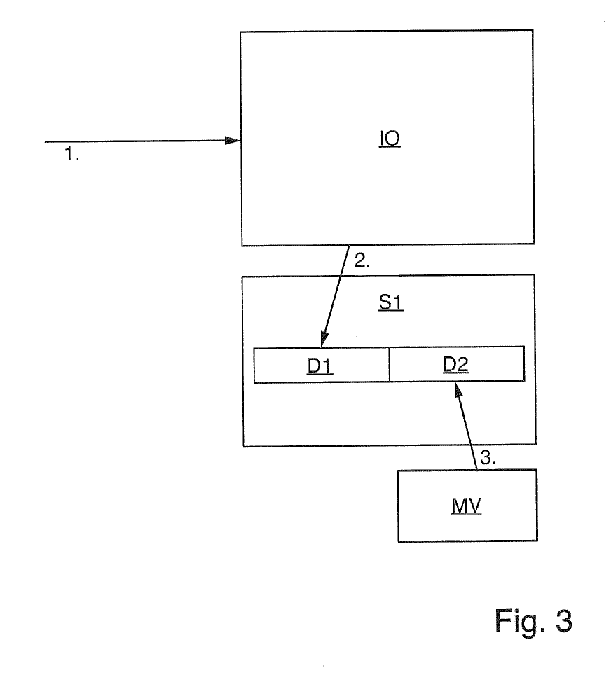

FIG. 3 a schematic representation of an attack, in the case of which a buffer overflow is to be achieved in the field device,

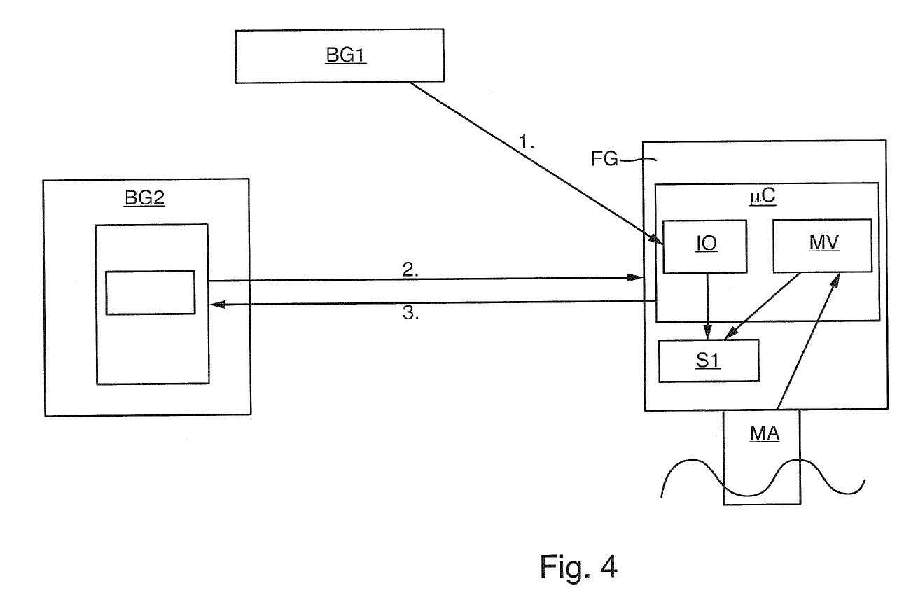

FIG. 4 a schematic representation of an attack on a servicing device, or on an application for servicing the field device,

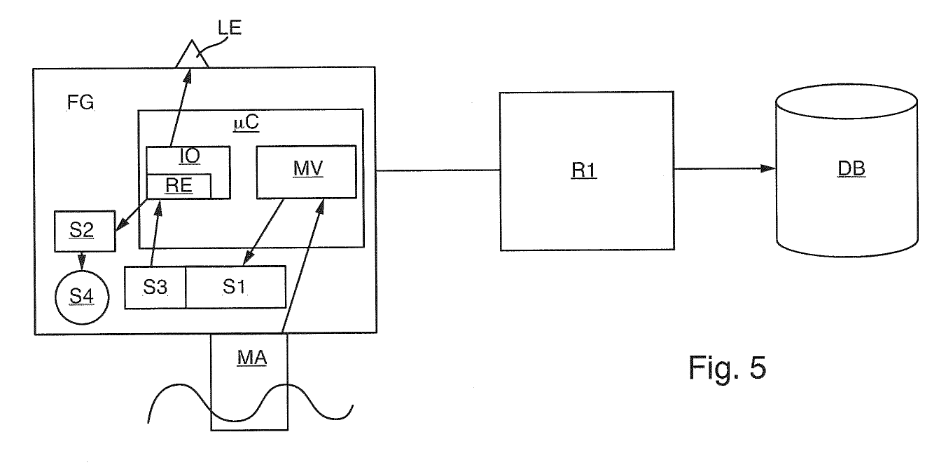

FIG. 5 a schematic representation of an arrangement comprising an operating device and an evaluation unit for evaluation of attacks on the field device registered by means of the first function block,

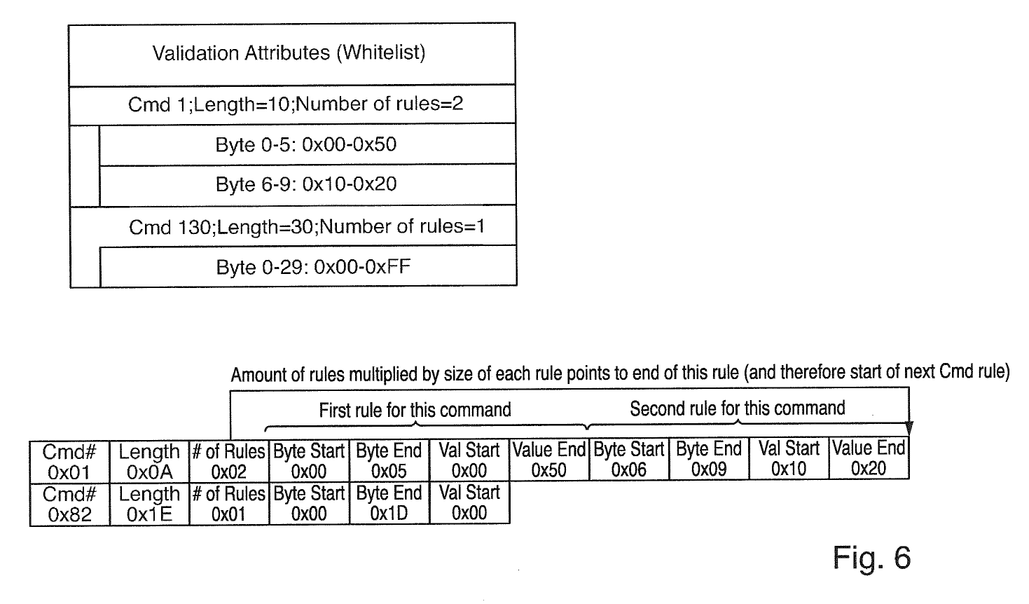

FIG. 6 a schematic representation of criteria for checking a telegram, or data block, received or sent by the field device.

FIG. 1 shows a field device FD having a measuring transducer MT, which transduces a chemical and/or physical, measured variable into an electrical signal, and a measured value processing logic MP, by means of which a measured value is produced from this measurement signal. The field device FD can be, for example, a temperature measuring device, a fill-level measuring device or flow measuring device. Besides the measured value processing logic MP, also an operating system can be provided, which manages the hardware of the field device FD and provides resources to applications, such as, for example, the measured value processing logic MR Furthermore, a communication interface (hardware) and an application IO (software) for operating the communication interface can be provided. These applications IO, MP can be implemented as separate function blocks or integrated as function blocks in the firmware of the field device. Firmware and function blocks IO, MP can, such as shown in FIG. 1, be implemented, as regards hardware, by a microprocessor μC. It is, however, also possible, that a first microprocessor μC serves for performing the function block IO and a second microprocessor μC for performing the function block MP.

Furthermore, the field device FD includes a memory, or storage, unit S1. is Memory unit S1 has one or more memory ranges, which the function block IO and the function block MP access. For example, a measurement signal can be transmitted from the measuring transducer MT to the function block MP and a measured value ascertained by means of the measured value processing logic MP written into a memory range of the memory unit S1. Stored in the memory unit S1 can be, however, also other field device referenced data, such as, for example, parameters, parameter values, parameter names or other identifiers, e.g. a tag of the field device FD, or the like. The function block MP can access these data, in order to perform the measurement signal processing. Additionally, also the function block IO can access the memory unit S1 and the memory ranges of the memory unit S1, for example, in order to store received data there, or to read out data from the memory unit, in order to transmit these to another location, for example, a control unit or a servicing device, or service application.

To this end, the function block IO, which is, for example, a protocol stack of a fieldbus protocol, can call the data from the memory unit S1 and pack such into one or more telegrams. By means of this function block IO, also one or more data blocks can be extracted from a telegram, which was received via the communication interface, and this one or more data blocks can be written into the memory unit S1. Likewise, a further function block, which executes a certain, predetermined function, can be provided, which accesses the memory unit S1, in order to read and/or to store data there. Especially, one or more of these function blocks can be integrated into the firmware of the field device FD and/or be in communication with this, for example, via a field device internal data bus, for example, an Inter-Integrated Circuit bus.

Furthermore, an option is that data received via different communication interfaces of the field device are written into the memory unit S1. For example, for this purpose a number of protocol stacks can be provided, which serve for processing telegrams, which are received or transmitted via a certain communication interface in a certain format.

According to the form of embodiment of the field device in FIG. 1, the data is received by the field device FD in step 1 are neither checked as regards content, nor monitored as regards content, nor controlled as regards content. The received data are stored in step 2 in the memory unit S1. Likewise data from a function block MP can be stored in this memory unit S1 in a step 3. The data can be, for example, a measured value ascertained from a measurement signal in a step 4. The data contained in the memory unit can be transmitted in a step 5 via the fieldbus to another participant on the fieldbus. The measured value can be a chemical and/or physical variable of a measured material MM.

FIG. 2 shows a field device FD having a number of logically and/or physically separated memory units S1, S2, S3, S4.

If a telegram T1 is received by the field device, then according to the form of embodiment in FIG. 2, such is fed to the function block IO. This can break the received telegram apart corresponding to the structure predetermined by the applied protocol. Furthermore, a first function block RE can be provided, which preprocesses and checks the received telegram concerning whether the telegram, i.e. the content of the telegram, for example, the information content of a data block, corresponds to one or more predetermined criteria.

This function block RE and the therewith connected checking (as regards content) of the received data can also be situated before the processing by the function block IO. On the other hand, the checking of the received data can also occur after the processing by the function block IO.

By means of the function block RE, received data are checked based on criteria, which are furnished in a memory unit, or in a memory range, S3. In such case, data consistency is not checked, for example, by means of a checksum, but, instead, it is checked whether the received data have a value, or value range, valid according to a criterion or a number of criteria.

In order not to write the received data directly into a memory unit, or memory range, S1, to which also the function block MP has access, a logically and/or physically separate memory range, or memory unit, S2 is provided in the field device, for example, within a housing of the field device FD.

A telegram, for example, received by means of the communication stack is then written, for example, by means of the function block RE, into this memory range S2. The received data can then be checked based on the criteria and, for example, in the case, in which the data does not fulfill the criteria, written into a memory unit, or memory range, S4. If the received and checked data, in contrast, fulfills one or more of the predetermined criteria, then the data are written into the memory unit, or memory range, S1.

The criterion can be, for example, a data length, for example, the number of expected bits, respectively bytes, a character code, such as, for example, ASCII, and/or a number range, which is expected for one or more or all parameters of the field device.

For example, the telegram, or a data block contained therein, shown in FIG. 2 transmitted via the fieldbus to the field device has a certain length, which exceeds the expected data length. In a first part Di, for example, a command according to the fieldbus protocol can be contained, while the second part D2 contains additional, not expected data. For example, these data D2 can serve to produce a memory overflow (buffer overflow).

If now the data length of the received data block is checked by means of the function block RE, then an effect on the operation of the field device can be prevented.

For the case, in which a checking of data, e.g. a received telegram, delivers a negative result, thus the received data is written into the memory unit, or memory range, S4, an optical signaling, for example, triggered by the function block RE, can occur.

For example, it can be provided to check data received via a first telegram T1, for example, data received in one or more data blocks D1, D2, based on a first criterion. Furthermore, it can be provided to check data to be transmitted by the field device FD in a telegram in one or more data blocks before the transmission via the fieldbus based on a second criterion, which second criterion differs from the first criterion. For example, the second criterion can depend on an identification, which determines the participant to whom the telegram is to be transmitted by the field device FD.

The telegram T1 can be received by the field device in step 1 and be written into a memory unit S2 in a second step 2. In a third step, criteria from a memory range S3 are loaded and used by the function block RE for checking the received data. In step 4, data, which does not pass the checking, can be stored in a memory S4. These data are barred from additional processing. Data can furthermore likewise be stored into memory unit S1 by the function block MP or read-out therefrom in step 5. The data can be, for example, a measured value ascertained from a measurement signal in step 6 or data such as, for example, parameters/parameter values required for calculating the measured value.

FIG. 3 is a schematic representation of an attack, in the case of which a buffer overflow should be achieved in the field device FD. Similarly to the situation for the data block of FIG. 2, a telegram received (in step 1) includes a first part D1, which contains, for example, a fieldbus command. This part and an adjoining, second part D2 are then written (in step 2) into the memory unit S1, without being checked. Since the function block IO has allocated only a certain memory range, in order to represent an expected data length therein, the data in the data block D2 can supplementally over-write memory in the memory unit S1 and thereby, in given cases, influence the functioning of function block MP, for example, when this data is retrieved in step 3 from a memory range, which adjoins that for storing the data D1.

FIG. 4 shows a further scenario of an attack by means of a field device FD. Via a first service application, for example, in a first servicing device SD1, data can be transmitted in step 1 by means of a telegram T1 to a field device FD. The data contained in telegram T1 can relate, for example, to parameters or other field device referenced data. Present should be, for example, a so-called tag, which designates the measuring point, at which the field device is applied. This tag can be stored in the field device FD. Present is a telegram T1, which transmits a command for setting the tag contained in the field device FD. Instead of a tag of the form “measuring point 42”, however, the user data block, which should actually contain the field device name, contains, for example, an XML code, such as, for example, “xmlns=x-schema:http://url”. This code is, in case no checking of the received telegram is performed, written into a memory unit or memory range S1. If now the tag is queried by another service application, which is executed, for example, in a servicing device SD2 or the control unit of a plant in step 2 and read-out in step 3, then the code contained therein is transmitted to the service application. In this way, a malicious code can, in given cases, be executed or loaded into the service application in service device SD2 or even the control unit. In this way, plant safety or the information security of the plant can be endangered.

According to a form of embodiment of the invention, however, criteria can be furnished in the field device FD, based on which received and/or sent telegrams are checked as regards content. Preferably, data, which correspond to the predetermined criteria, i.e. data which does not meet such criteria, are stored in a memory unit, or a memory range, S4 in the field device FD. For example, this can be together with other information contained in the telegram T1, such as, for example, the originating address and/or a point in time, at which the telegram was received. Furthermore, also a counter can be provided, which gives information on how often a certain type of telegram or data block was received. Based on the counter, it can then be decided, whether the acceptance of additional telegrams should be blocked. For example, if many bad telegrams with equal form are being received, the counter can then display, for instance, that already 100 of these telegrams have been received. Thereupon, the field device can decide that the processing of further telegrams is completely terminated, in order to prevent overloading of the microprocessor μC by bad telegrams, e.g. in order to avoid a denial of service. This can either concern all received telegrams (in the case of HART, the primary measured value would still be received via 4-20 mA) or, instead, the field device would simply immediately discard a certain type of query (e.g. telegrams from a certain address are immediately dropped without further testing), however, still process others.

According to FIG. 5, in the case of a field device FD, which has such a function block RE for checking data, the data stored in the memory unit, or memory range, S4 can be read-out by means of a service application. For example, such a read-out of the field device can be reserved for the manufacturer. Especially, this can only occur via an on-site interface to the field device. These collected data can then be evaluated, for example, in order to prevent or to be able to exclude future attacks. For example, a database can be provided, in which data collected from different field devices are stored. Based on these data present in the database, then other criteria can be determined or established, based on which, data, which the field device checks in the function block RE, can be split out.

FIG. 6 shows a so-called whitelist, which contains criteria for checking received data. Only data, which fulfill these criteria, are permitted to pass to a second function block for additional processing. All other data are diverted, for example, into a separate memory unit, or memory range, S4.

Instead of that, however, also a so-called blacklist can be used, which allows all data to pass to additional processing and only splits out data, which fulfill the criteria of the blacklist.

The whitelist set forth in FIG. 5 establishes attributes (criteria), which relate to a first command. Furthermore, the whitelist contains attributes regarding a second command. If a telegram is received, which contains the command “1”, or the command “130”, as the case may be, the attributes relevant to the respective command, attributes which relate to, for example, the data contained in a user data block of the telegram, are used for checking this data.

For example, it can be established by the criteria that a data block following a command has a length of a certain number of bytes, for example, a maximum of 10 bytes. Furthermore, it can also be specified that, for checking a telegram or a data block following a command, a number of criteria, here two, be used.

This (user-)data block of a telegram can for checking be divided into other sub data blocks, for example, data amounts. For example, a first criterion can relate to a first amount of data, which, for example, such as shown in FIG. 6, is composed of bytes 0-5, and to a second amount of data, which is composed of bytes 6-9. Due to empirical values or due to specifications of the used protocol or due to the type of field device, it can be established whether the data contained in the first portion have a certain, valid value, such as, for example, a certain, valid, hexadecimal value. For this, value ranges can be specified for the first portion and for the second portion.

The second table in FIG. 6 shows schematically the composition of criteria, which are used for checking received data, for example, by means of the function block RE.

For example, a command can be given, which should be checked. For example, commands can be checked, which require a write access to the memory of the field device. Furthermore, it can be specified that these commands and/or the thereon following user data must not exceed a certain length. Furthermore, values, or value ranges, can be specified for certain portions. Furthermore, it can be checked whether individual bytes, such as, for example, start and/or end-bytes of a certain portion, have a certain value. This can occur for different portions and or commands.

1. Method for checking at least one telegram (T1) transmitted via a fieldbus according to a fieldbus protocol, wherein the telegram (T1), which has at least one data block (D1, D2), is received by a field device (FD), which field device (FD) has a first function block (RE) for preprocessing the received telegram (T1), wherein based on the preprocessing it is checked whether the data contained in the at least one data block (D1, D2) correspond to predetermined criteria furnished in the field device, for example, a predetermined value or a predetermined value range (Cmd#, Length, byte start, etc), wherein based on the checking it is determined, whether the received data are forwarded to a second function block (MP, IO) for further processing of the received data in the field device (FD).

2. Method as claimed in claim 1, wherein the received data are written, as a function of the checking, into a first memory range (S4) or into a second memory range (S1) in the field device (FD).

3. Method as claimed in claim 2, wherein the first memory range (S4) serves to store, persistently, data, which do not fulfill the predetermined criteria,.

4. Method as claimed in claim 3, wherein the second memory range (S1) serves to provide the received data to the second function block (MP, IO) in the field device (FD), by which second function block (MP, IO) the received data are further processed.

5. Method as claimed in claim 4, wherein the first function block (RE) checks whether a first portion (byte 0-5) of data contained in the data block (D1, D2) corresponds to a first criterion (0x00-0x50).

6. Method as claimed in claim 5, wherein the first function block (RE) checks whether a second portion (byte 6-9) of data contained in the data block (D1, D2), different from the first portion (byte 0-5), corresponds to a second criterion (0x10-0x20).

7. Method as claimed in claim 6, wherein the at least one telegram (T1) includes first and second data blocks (D1, D2), and wherein in the field device (FD) a first set of criteria is furnished, based on which the first data block (D1) is checked, wherein in the field device (FD) a second set of criteria are furnished, based on which the second data block (D2) is checked, wherein the first and second sets of criteria differ from one another.

8. Method as claimed in claim 7, wherein the telegram (T1), i.e. the at least one data block (D1, D2), is written into a third memory range (S2) of the field device (FD) before the checking by the first function block (RE).

9. Method as claimed in claim 8, wherein, as a function of the checking, data are written, preferably copied, from the third memory range (S2) either into the first or into the second memory range (S4, S1).

10. Method as claimed in claim 9, wherein the criteria, based on which the at least one telegram (T1), i.e. the data contained in the telegram, is/are checked, are stored in a fourth memory range (S3) in the field device (FD).

11. Method as claimed in claim 10, wherein, using the criteria, it is checked whether the values contained in the data block (D1, D2) lie within a predetermined value range, for example, in a predetermined hexadecimal value range (0x00-0xFF).

12. Method as claimed in claim 11, wherein it is checked based on the criteria, whether the data block (D1, D2) exceeds a predetermined amount of data (Length).

13. Field device (FD) having a first function block (RE), which serves for preprocessing at least one received telegram (T1), which has at least one data block (D1, D2), wherein the first function block (RE) serves, furthermore, to check whether the data contained in the at least one data block (D1, D2) meet predetermined criteria furnished in the field device (FD), for example, have a predetermined value or a predetermined value range, and whether it is permissible to forward the received data to a second function block (MP, IO) for further processing of the received data in the field device (FD).

14. Field device (FD) as claimed in claim 13, wherein the field device includes a first memory range (S4) and a second memory range (S1), in which the received data are stored as a function of checking by the first function block (RE).
